(19) United States
(12) Patent Application Publication
(10) Pub. No.: US 2012/0102801 A1
(43) Pub. Date: May 3, 2012

(54) LED-ILLUMINATED SIGNBOARD METALLIC-CASED

(76) Inventor: Min Kyu LEE, Seoul (KR)

(21) Appl. No.: 13/179,874

(22) Filed: Jul. 11, 2011

(30) Foreign Application Priority Data
Oct. 29, 2010 (KR) 10-2010-0106583
May 28, 2011 (KR) 10-2011-0050984

(51) Int. Cl. G09F 13/06

(52) U.S. Cl. 40/579

(57) ABSTRACT

An LED-illuminated signboard metallic-cased is a signboard that is capable of directing a variety of images by having a plurality of microscopic holes in the metal panel be formed and making the light emitted from the LED get through. The signboard comprises: base frame, and LED module part placed in said base frame, and front metal panel coupled to the front of said base frame and having plurality of microscopic holes formed on the entire surface. Therefore in the present invention, a metallic material of luxurious image is utilized for the front panel of LED-illuminated signboard metallic-cased, and there is an effect that luxurious and differential promotion performance can be.

### CROSS REFERENCES

Applicant claims foreign priority under Paris Convention and 35 U.S.C. §119 to Korean Patent Application Nos. 10-2010-0106583 filed 29 Oct. 2010, and 10-2011-0050984 filed 28 May 2011, with the Korean Intellectual Property Office, where the entire contents are incorporated herein by reference.

### BACKGROUND OF THE INVENTION

The present invention relates to a board with LED lighting, and is intended to provide LED-illuminated signboard metallic-cased that is capable of directing a variety of images by having a plurality of microscopic holes in the metal panel be formed and making the light emitted from the LED get through.

In general, signboards will be installed in a prominent place—shops, Companies, offices, other agencies, etc.—by displaying trademarks, service marks and trade names, so it has been widely used one of the advertising/marketing tools.

In particular recently, the demand for sign board has been a dramatic increase.

The reason for this is because that the LED contribute greatly to energy savings and has a longer life, lower maintenance cost and less power consumption with high reliability compared to other lighting fixtures, in additionally are suitable for use with lighting/signboards because of relatively small the design flexibility and heat generation.

Typically in a conventional LED signboard, LED Module which acts as light source is installed on the inside and the front panel are manufactured from materials of nature to pass lights for the light transmission.

However, the conventional LED signboard have a problem that can not be placed inside the LED module if you want to use material does not have the nature to pass light as the front panel like metal.

So, in the conventional technology it was limited only produce shining on the surface of metal panels by placing the light source separated on the front panel of metal panels and projecting the light in the direction of the metal panel.

### SUMMARY OF THE INVENTION

The present invention in order to solve these problems of conventional, aims to provide LED illuminated signboard that enable to produce several different images with metallic case by forming many micro-holes on the surface of the metal front panel that do not have the properties of light passing and by being placed inside the light.

The purpose of the present invention is to provide LED-illuminated signboard metallic-cased included ; base frame, and LED module part placed on the shape of at least one or more in the middle of letters, shapes, patterns or symbols to represent in said base frame, and front metal panel coupled to the front of said base frame and having plurality of microscopic holes formed in the corresponding position against minor portion of the said LED module part is placed.

The another purpose of the present invention is to provide LED-illuminated signboard metallic-cased included ; base frame, and LED module part placed at least on one portion in said base frame, and front metal panel coupled to the front of said base frame and having plurality of microscopic holes formed on the shape of at least one or more in the middle of letters, shapes, patterns or symbols to represent.

The other purpose of the present invention is to provide LED-illuminated signboard metallic-cased included ; base frame, and LED module part placed in said base frame, and front metal panel coupled to the front of said base frame and having plurality of microscopic holes formed on the entire surface.

In this present invention LED-illuminated signboard metallic-cased, it is possible to have a control part that control the performance of said LED module part.

In addition to this present invention LED-illuminated signboard metallic-cased, the said plurality of microscopic holes are; formed with a diameter less than 3 mm, and formed on panel-used metal for said front metal panel by projecting a laser beam precisely controlled, and formed on panel-used metal for said front metal panel by etching, and enable to be filled by a transparent material which pass the emitting state performed in said LED module part.

In addition to this present invention LED-illuminated signboard metallic-cased, the said front metal panel are ; enable to be coated on the surface, and placed the resin layer of characteristic of passing light between said base frame and said front metal panel.

Besides, each component part and detailed technical information about each is provided, and this each component part and detailed technical information can be implemented individually or in combination with each other.

Therefore according to the present invention, the main effect of this LED-illuminated signboard metallic-cased as follows:

This present invention LED-illuminated signboard metallic-cased provide the effects that can be projected light to the front from the back of the front panel which do not have the properties of light passing by being formed a plurality of microscopic holes on the surface of the metal front panel.

In addition, in the present invention a metallic material of luxurious image is utilized for the front panel of LED-illuminated signboard metallic-cased, and there is an effect that luxurious and differential promotion performance can be.

### BRIEF DESCRIPTION OF DRAWINGS

FIG. 1 is a view of LED-illuminated signboard metallic-cased according to an embodiment of the present invention;

FIG. 2 is a view of the front metal panel of LED-illuminated signboard metallic-cased of FIG. 1;

FIG. 3 is a view to explain an embodiment of forming microscopic holes on the front metal panel of LED-illuminated signboard metallic-cased of FIG. 1;

FIG. 4 is a view to explain another embodiment of forming microscopic holes on the front metal panel of LED-illuminated signboard metallic-cased of FIG. 1;

FIG. 5 is a concept view of separating LED-illuminated signboard metallic-cased according to an embodiment of the present invention;

FIG. 6 is a concept view of separating LED-illuminated signboard metallic-cased according to another embodiment of the present invention;

FIGS. 7a to 7c are image views of operated LED-illuminated signboard metallic-cased according to an embodiment of the present invention;

### DETAILED DESCRIPTION OF THE INVENTION

Hereafter, LED-illuminated signboard metallic-cased of the present invention is described in detail by referring to the attached drawings.

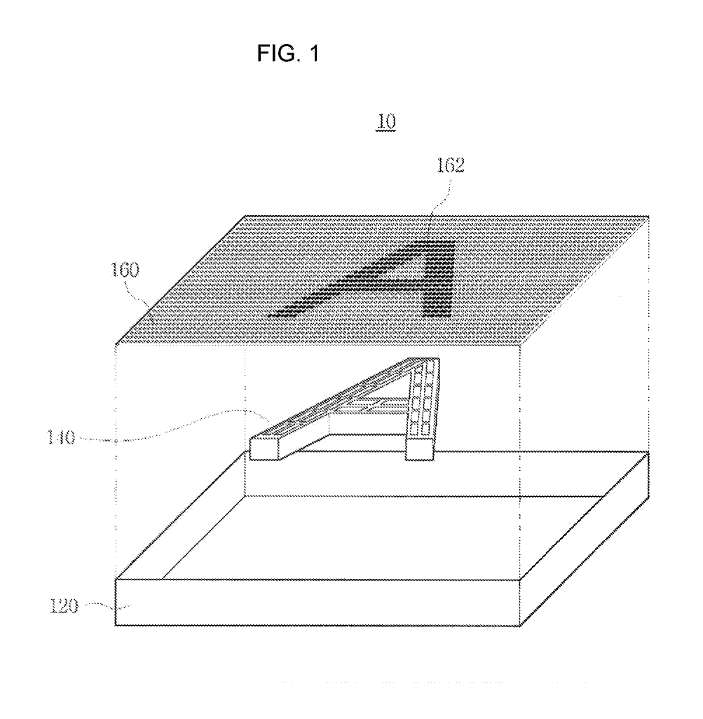

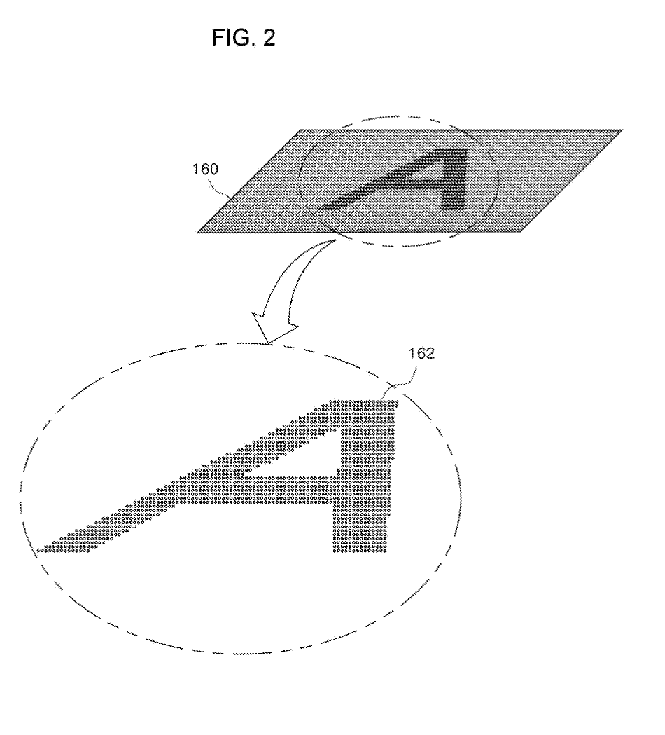

FIG. 1 is a view of LED-illuminated signboard metallic-cased according to an embodiment of the present invention, and FIG. 2 is a view of the front metal panel of LED-illuminated signboard metallic-cased of FIG. 1.

As shown in FIGS., the present embodiment of LED-illuminated signboard metallic-cased (10) include base frame (120), LED module part (140) and front metal panel (160).

The base frame (120) perform the role that fixate the overall shape of LED-illuminated signboard metallic-cased (10), the shape of base frame (120) is not limited. For example, the base frame (120) can be formed by multiple frames, such as triangular or rectangular frame. In the following description for convenience, but described in the case focused on the base frame (1 20) of square type are in progress.

Base frame (120) can be formed the top surface opened, additionally in including side part and bottom part. Meanwhile, the base frame (120) can further include tightening means fixed or hanged to a wall. For example, the base frame (120) can be immobilizing minor part of the upper on the wall through bolts and so on, and hung on a protrusion or a hook by forcing the upper of the side part to hang the ring and the strap associated with the ring said.

Meanwhile, the base frame (120) can be blocked many spaces by installing a large number of multiple barrier inside. In addition, the base frame (120) can be placed channel character frame by installing a large number of multiple barrier said inside.

Base frame (120) of the material is not limited. For example, the base frame (120) can be of metal or plastic.

LED module part (140) consists of a plurality of LED modules, and acts as a light source emitting. LED module part (140) is placed in the base frame (120), if it can be produced needed performance base frame (1 20) is not limited on the bottom or the sides. Additionally, LED module part (140) can be formed on the shape of at least one or more in the middle of letters, shapes, patterns or symbols to represent. However, hereinafter for convenience of description, as shown in FIG. 2, it is described in focusing the case that LED module part (140) is formed on ‘A’ shape.

For example, LED module part (140) have the bulkhead installed on the ‘A’ shape, and can be placed inside in the bulkhead said. In addition, LED module part (140) itself without having the bulkhead above can be formed on ‘A’ shape.

LED module part (140) can include PCB circuit boards (not shown) formed a circuit that provides power and electrical signals to LED modules and LED modules mounted on said PCB circuit boards. In addition, said PCB circuit board can further include Control Part (not shown) controlling at least one of the lighting sequence, lighting speed, Flashing, blinking rate or color. Meanwhile, said LED modules can be at least one of Red LED chips, green LED chips and the blue LED chip.

Meanwhile, LED module part (140) can be packaged waterproofer (not shown). In this case, moisture and dust are prevented to entering into LED module part (140), it is possible to extend the life of that.

Front metal panel (160) is the front of the sign board, and is coupled to the front of base frame (120). In addition, the plurality of microscopic holes is formed at least on one part in the metal front panel (160). Specifically, microscopic holes (162) can be formed in the corresponding position that LED module part (140) is placed.

For example, when LED module part (140) is placed the ‘A’ shape inside the base frame (120), microscopic holes (162) can be formed to achieve the same shape to said ‘A’ shape at the surface corresponding to LED module part (140) on the state combined with base frame (120).

In the past, if you are using metal to the panel, there are problems that metals can not be used as the front panel because light source such as LED illumination can not be placed inside depending on nature of light passing in the metal.

But on embodiments of the present invention it is characterized that light irradiated from the light source placed inside can be permeable front part by being formed a plurality of microscopic holes in front of the front panel made of metal.

Front metal panel (160) is manufactured by a metal material. For example, a metal front panel (160) can be prepared manufactured by aluminum, iron or stainless steel, etc.

Also in this embodiment of LED-illuminated signboard metallic-cased (10), microscopic holes (162) is formed generally small that the human eye identify difficultly, for example, micrometer [μm] to hundreds of micrometer [μm].

Of course, LED-illuminated signboard metallic-cased (10) can be formed few microseconds [μm] less or few millimeters [mm] larger in size, but it is so closely related production costs, performance effects to implement, and so on. In other words, if microscopic holes (162) is formed as the size of few millimeters [mm] range (which is understood later in the process), performance effect is reduced because the image of cell that is produced is large. Conversely, when LED-illuminated signboard metallic-cased (10) is manufactured with less than a few micrometers [μm] it is cost to form microscopic holes (162), furthermore it is accompanied by several problems that the thickness of front metal panel (160) must be thin because of the problem of LED light projecting and the viewing angle narrowed.

Therefore on this LED-illuminated signboard metallic-cased (10), microscopic holes (162) that is formed 3 [mm] or less will have a sense. However, in this embodiment it is described in focusing the case that microscopic holes (162) are formed 50 micrometer [μm].

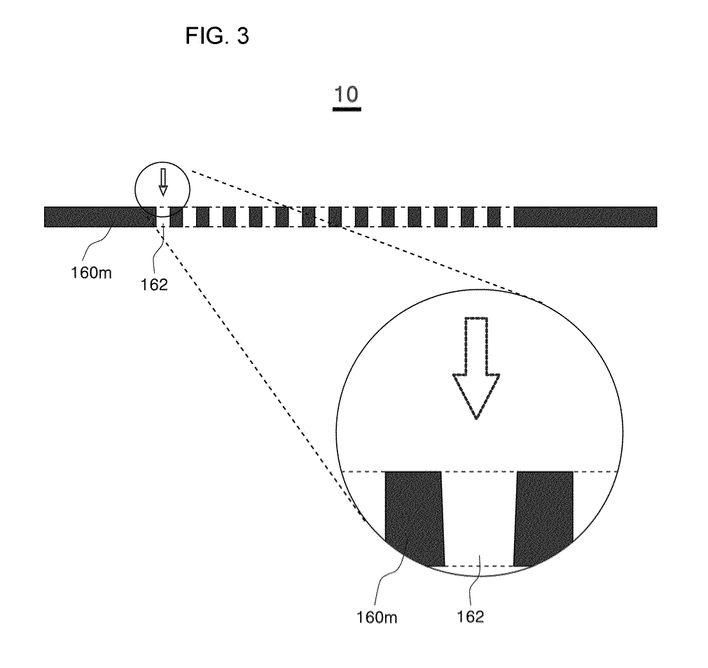

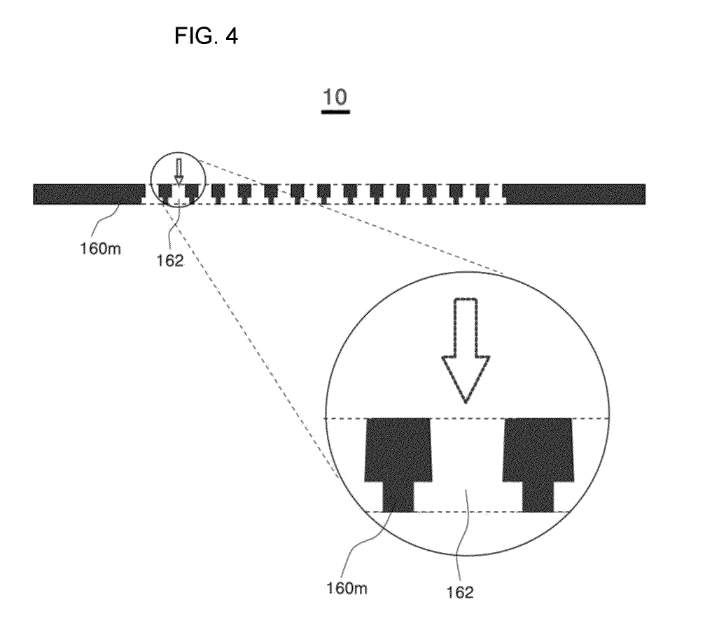

FIG. 3 is a view to explain an embodiment of forming microscopic holes on the front metal panel of LED-illuminated signboard metallic-cased of FIG. 1, and FIG. 4 is a view to explain another embodiment of forming microscopic holes on the front metal panel of LED-illuminated signboard metallic-cased of FIG. 1.

As shown in FIG. 3, in this embodiment of LED-illuminated signboard metallic-cased (10), microscopic holes (162) are formed by projecting the laser beam from the laser machine for a certain period of time; 0.1 millisecond [msec] as shown in arrow in this embodiment.

Of course, this control process is required very precise control of machining. In other words in this embodiment, to should be made precise control is very natural because the distance to the neighboring microscopic hole (162) is 100 micrometer [μm] as twice to 50 micrometer [μm] of microscopic hole (162) diameter.

Besides in this embodiment of LED-illuminated signboard metallic-cased (10), as shown in FIG. 4, microscopic hole (162) according to this embodiment can be even formed by introducing etching process.

When microscopic holes (162) is manufactured by etching process, first of all as shown in arrows a preliminary home (162s) for microscopic holes (162) is formed by firing a laser beam of the laser machine above the top of metal (160m) for front panel. Since then, microscopic holes (162) is formed by being formed Etching Home (162e) through performing etching process to a certain depth at the bottom of Preliminary home (162s). It is possible to form better shape as microscopic hole (162) which is weak shape by manufacturing with the laser machine.

In addition, this processes are also possible to perform the change depending on the needs, and Preliminary home (162s) and etching Home (162e) all can be formed by etching process.

Microscopic hole (162) formed by this process is filled with transparent material depending on the needs, or the surface of metal (160m) for front panel is also possible to be coated. However, because this process is related to heighten performance effect according to good passing of LED light-emitting it is preferably carried out in state well-considered many situations.

This process is the processing method used for manufacturing microscopic hole (162) to metal when the thickness of the metal is relatively thick and machining is difficult through the laser beam. Of course, it is possible to process non-strong natured metal.

LED-illuminated signboard metallic-cased (10) of the present embodiment can further include the material that pass the light between base frame (120) and metal front panel (160). The said material of passing light perform the function to prevent infiltration of dust or moisture through microscopic holes (162). The said material of passing light, for example, is preferable the resin of passing light such as acrylic resin. The said material of passing light can be seated between sheets or attached to the front or rear of microscopic holes (162).

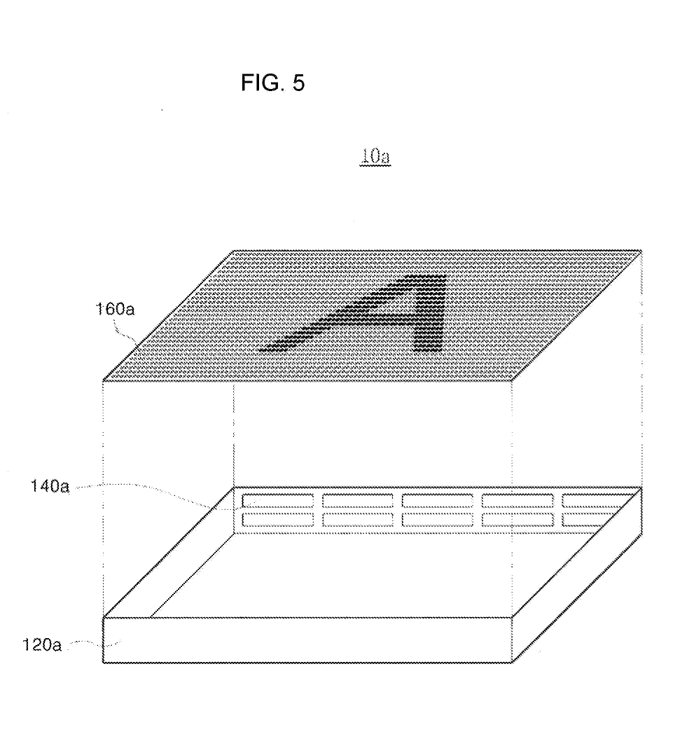

FIG. 5 is a concept view of separating LED-illuminated signboard metallic-cased according to an embodiment of the present invention.

As shown, this LED-illuminated signboard metallic-cased (10) include; the base frame (120a), and LED module part (140a) placed in at least one internal portion of the base frame (120a), and front metal panel (160a) formed microscopic holes (162a) on the surface and coupled to the front of the base frame (120a).

Because the base frame (120a), LED module part (140a), microscopic holes (162a) and front metal panel (160a) can be made with the same or similar to above said embodiments here the description is omitted, it will be described mainly in different parts to the foregoing embodiment.

In LED-illuminated signboard metallic-cased (10) of the present embodiment, plurality of microscopic holes are formed on the shape of at least one or more in the middle of letters, shapes, patterns or symbols to represent at the front of front metal panel, it is characterized that the shape which microscopic holes (162a) form can be displayed.

Unlike the aforementioned embodiments in LED-illuminated signboard metallic-cased (10) of the present embodiment, the LED module part (140a) only should be placed inside base frame (120a), shapes to express to the outside can be formed to microscopic holes (162a) placed in front of metal front panel (160a).

This LED-illuminated signboard metallic-cased (10a) can be include; the control unit to control LED module part (140a), waterproof to package LED module part (140a), material of passing light to prevent dirt, moisture and water penetration through the microscopic holes (162a). because the said control unit, the said waterproof and the said material of passing light can be made with the same or similar to above said embodiments here the description is omitted.

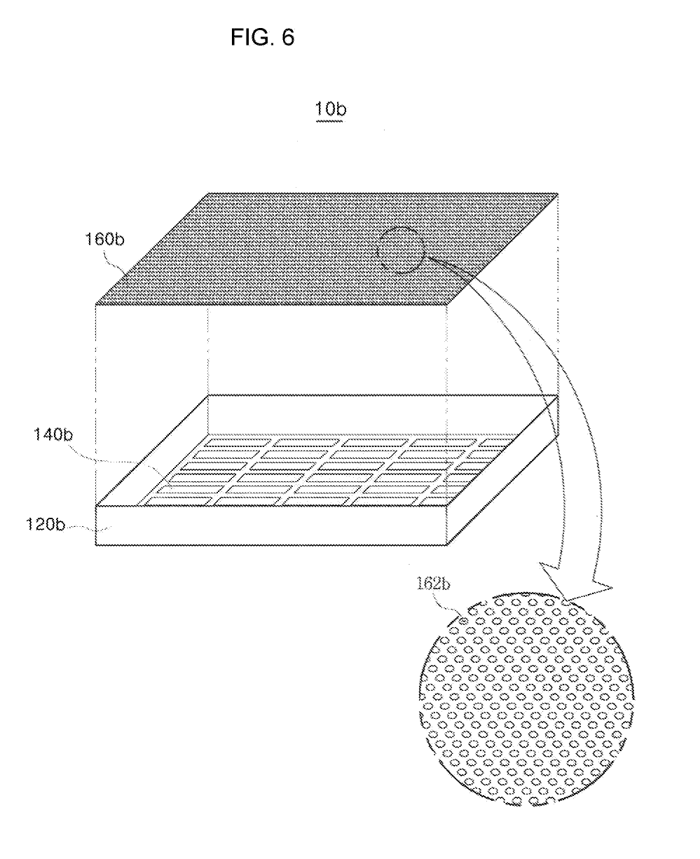

FIG. 6 is a concept view of separating LED-illuminated signboard metallic-cased according to another embodiment of the present invention.

As shown, this LED-illuminated signboard metallic-cased (10) of the present embodiment include; the base frame (120b), and LED module part (140b) placed inside the base frame (120b), and front metal panel (160b) formed plurality of microscopic holes (162b) on the entire surface without borders and coupled to the front of the base frame (120b).

Because the base frame (120b), LED module part (140b), microscopic holes (162b) and front metal panel (160b) can be made with the same or similar to above said embodiments here the description is omitted, it will be described mainly in different parts to the foregoing embodiment.

In LED-illuminated signboard metallic-cased (10) of the present embodiment because microscopic holes (162b) is formed on the entire front of metal front panel (160b) various rendering effects can be achieved according to the emitting-state implemented by LED module part (140b). The LED module part (140b) is composed including LED modules and PCB board providing power and electrical signals to LED modules, and the said PCB board further includes control unit to control at least one or more in the middle of lighting order, lighting speed, blinking order, blinking speed and color by controlling the LED module part (140b).

Thus, the said control unit can express freely letters, shapes, patterns or symbols to represent on metal front panel (160b).

In other words, like the foregoing embodiments the performance was not limited according to the placement of LED module part (140b) or the arrangement of microscopic holes (162b) formed on the front of metal front panel (160b).

On the other hand, This LED-illuminated signboard metallic-cased (10b) can be include; the control unit to control LED module part (140b), waterproof to package LED module part (140b), material of passing light to prevent dirt, moisture and water penetration through the microscopic holes (162b). because the said control unit, the said waterproof and the said material of passing light can be made with the same or similar to above said embodiments here the description is omitted.

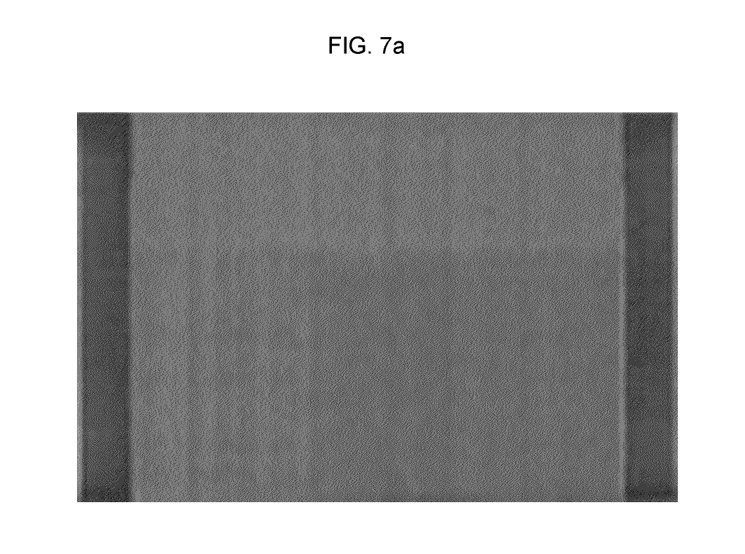

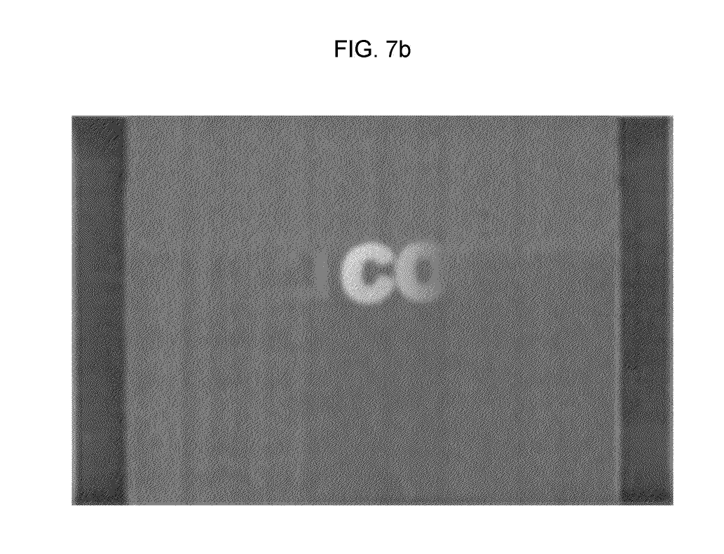

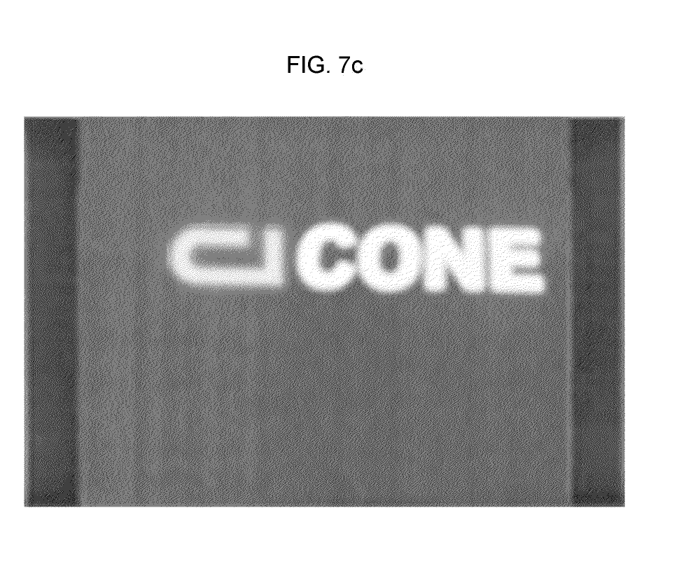

FIGS. 7a to 7c are image views of operated LED-illuminated signboard metallic-cased according to an embodiment of the present invention.

As shown, if there is a luminous of LED module part (140), the front of metal front panel (160) will look like a normal metal (also see FIG. 7a).

In contrast, when LED module part (140) are emitting, the shape corresponding to the placement of LED module part (140) will appear on metal front panel (160) because light transmit through the microscopic holes (1 62) of metal front panel (160) (also see FIG. 7c). Therefore, by using this phenomenon it can be implemented in a various performance of metal front panel (160).

In addition, various performance effect can be achieved by controlling lighting order, lighting speed, blinking order, blinking speed and color in the said control unit connected to the PCB of LED module part (140) (also see FIG. 7b).

As mentioned above, in LED-illuminated signboard metallic-cased (10) of the present invention, there is the effect that light can be projected to the front from the rear of the front panel apparently blocked.

In addition, by using the metal materials of the luxurious image to the front panel of signboard of a metal sign at the front panel of the board, there is the effect that an elegant and distinctive performance can be achieved in this signboard.

In addition, LED-illuminated signboard metallic-cased (10) according to an embodiment of the present invention can be used variously with indoor or outdoor signboards of shops and institutions, accessories, interior and exterior decor, car signs, etc.

As mentioned above, this description contains a description of specific embodiments but this invention is not limited to this, and it can be conducted as well as a variety within the rangr without departing the concept of the present invention by persons with ordinary skill in this art, these various implementations will have the right to belong to the range of present invention.

What is claimed is:

1. A LED-illuminated signboard metallic-cased comprising: base frame, and LED module part placed in said base frame, and front metal panel coupled to the front of said base frame and having plurality of microscopic holes formed on the entire surface.

2. The LED-illuminated signboard metallic-cased according to claim 1 characterized in that adding;
said base frame, and LED module part placed on the shape of at least one or more in the middle of letters, shapes, patterns or symbols to represent in said base frame, and front metal panel coupled to the front of said base frame and having plurality of microscopic holes formed in the corresponding position against minor portion of the said LED module part is placed.

3. The LED-illuminated signboard metallic-cased according to claim 1 characterized in that adding;
said base frame, and LED module part placed at least on one portion in said base frame, and front metal panel coupled to the front of said base frame and having plurality of microscopic holes formed on the shape of at least one or more in the middle of letters, shapes, patterns or symbols to represent.

4. The LED-illuminated signboard metallic-cased according to claim 1, characterized in that adding a control part that control the performance of said LED module part.

5. The plurality of microscopic holes according to claim 1, characterized in that formed with a diameter less than 3mm.

6. The plurality of microscopic holes according to claim 1, characterized in that formed on panel-used metal for said front metal panel by projecting a laser beam precisely controlled.

7. The plurality of microscopic holes according to claim 1, characterized in that formed on panel-used metal for said front metal panel by etching.

8. The plurality of microscopic holes according to claim 1, characterized in that enable to be filled by a transparent material which pass the emitting state performed in said LED module part.

9. The front metal panel according to claim 1, characterized in that enable to be coated on the surface.

10. The LED-illuminated signboard metallic-eased according to claim 1, characterized in that placed the resin layer of characteristic of passing light between said base frame and said front metal panel.
